(19) United States
(12) Patent Application Publication
(10) Pub. No.: US 2015/0318776 A1
(43) Pub. Date: Nov. 5, 2015

(54) POWER GENERATING DEVICE AND OBJECT EMBEEDING THE SAME

(71) Applicant: SHEN-KO TSENG, TAIPEI CITY (TW)

(72) Inventor: SHEN-KO TSENG, TAIPEI CITY (TW)

(21) Appl. No.: 14/700,119

(22) Filed: Apr. 29, 2015

(30) Foreign Application Priority Data
Apr. 30, 2014 (CN) 201410180668.9

(51) Int. Cl. H02K 35/02; H05B 33/08; H02K 11/00

(52) U.S. Cl. CPC H02K 35/02; H02K 11/001; H05B 33/0806

(57) ABSTRACT

The present invention discloses a power generating device, comprising a first shell, a magnetic module, and a sensor module. A first magnetic element is configured in the magnetic module. A portion of the magnetic module is configured in the first shell and movably connected to the first shell. A portion of the magnetic module is passed through the second shell and jutted out from the second shell. The sensor module is configured in the first shell, comprising a magnetism element and an induction coil coiled on or over the magnetism element. When an external force is applied on the magnetic module or the first shell, the magnetic module and the sensor module will generate a relative movement that drives the first magnetic element and the induction coil to generate a relative movement along a vertical direction, which allows the induction coil to induct a change in magnetic flux to generate an induced current.

### BACKGROUND OF THE INVENTION

1. Field of the Invention

The present invention relates to a power generating device, more particularly, to a power generating device using electromagnetic induction to generate power.

2. Description of the Prior Art

In order to comply with the current worldwide trend of energy conservation and environmental protection, many practical and energy-saving products are being sold in the market. Among them, the products that can generate power through simple actions performed by its users not only achieve the goal of energy conservation and environmental protection but also fulfills the need to be innovative and interesting. An example of such products that can generate power are flashlights that can generate power through force generated from a hand and bicycles that can change mechanical energy to electrical energy.

In another example, when a pedestrian is walking at night where the light surrounding them is inadequate, traffic accidents have a higher probability of happening. Because of this, pedestrians often need to equip reflective devices or self-luminous devices to increase their visibility at night. Because the self-luminous devices need to be carried everywhere, thin-type batteries are usually set inside the devices. However, the thin-type battery mentioned above contains mercury, which causes pollution to the environment. Additionally, if the devices do not have the appropriate waterproofing ability, the battery mentioned above will more likely have problems such as current leakage, damping, or damage.

To summarize the statement mentioned above, if the self-luminous devices can generate power through simple actions performed by its users and the structure inside is simple and does not need high grade waterproofing equipment, the mercury battery with high pollution will no longer be needed to, which is more convenient for the pedestrian to use while also increasing the traffic security of the pedestrian. Therefore, a device capable of solving the aforementioned problems above has extremely high practicality and is a constant problem every company in the industry actively wants to solve.

### SUMMARY OF THE INVENTION

An object of the present invention is to provide a power generating device that can generate power through simple actions performed by its users. Therefore, the mercury battery that causes pollution does not need to be set in the devices, and the traffic security of the pedestrian can be increased through the generated LED light source.

According to an embodiment of the present invention, the power generating device of the present invention comprises a first shell, a magnetic module, and a sensor module. The first shell has a first hollow portion and a first opening portion; the magnetic module has a base portion and at least one first magnetic element; the sensor module is configured in the first hollow portion, wherein the sensor module comprises a magnetism element and an induction coil winded on the magnetism element, wherein the magnetism element comprises a first terminal and a second terminal, where a slide gap of the magnetism element is formed between the first terminal and the second terminal. When an external force is applied on the power generating device to allow the magnetic module and the sensor module to generate a relative movement, the first magnetic element moves along a force applied direction of the external force relatively to the slide gap of the magnetism element, to allow the induction coil to induct a change in the magnetic flux to generate an induced current.

Based on the design mentioned above, the present invention can further selectively comprise a second shell, covering the first opening portion, wherein the second shell has a second opening portion for the magnetic module to pass through, wherein a bottom surface of the base portion is positioned in the first hollow portion.

Based on the design mentioned above, the present invention can further selectively comprise a third shell, covering the second shell, wherein when the external force is applied on the power generating device to deform the third shell, the third shell will drive the base portion of the magnetic module to move into the first hollow portion.

Based on the design mentioned above, the present invention can further selectively comprise a magnetic module, that further comprises an exposed portion that is connected to the base portion, and when an external force is not applied to the power generating device, a top surface of the exposed portion can pass through the second shell to the position between the second shell and the third shell.

Additionally, the present invention can further selectively comprise at least one elastic element that is configured between the base portion of the magnetic module and the first shell, and when external force is applied on the power generating device to deform the elastic element, the elastic element provides a recovery force to resist the external force, and the first magnetic element moves back and forth in the slide gap along the applied direction of the external force relative to the magnetism element (for example, the first magnetic element moves back and forth along the slide gap) using the external force and the recovery force.

Moreover, the magnetism element of the sensor module of the present invention can selectively comprise a first sensor arm and a second sensor arm. The first sensor arm comprises a first sensor portion and a first fixture portion, where the first fixture portion is configured on the first shell and the first sensor portion is extended from the first fixture portion to the first terminal of the magnetism element. The second sensor arm comprises a second sensor portion and a second fixture portion, where the second fixture portion is configured on the first shell and the second sensor portion is extended from the second fixture portion to the second terminal of the magnetism element. The slide gap of the magnetism element formed between the first sensor portion and the second sensor portion is used to allow the first magnetic element of the magnetic module to be moved in.

Based on the design mentioned above, the base portion of the magnetic module of the present invention can further selectively have an activity space, a first seat opening, and a second seat opening. The activity space is connected to the first hollow portion through the first seat opening and the second seat opening. The first sensor arm of the sensor module enters the activity space through the first seat opening in order to be configured on one side of the first magnetic element. The second sensor arm of the sensor module enters the activity space through the second seat opening in order to be configured on the other side of the first magnetic element. Therefore, the first terminal and the second terminal of the magnetism element are positioned in the activity space in which the first sensor arm and the second sensor arm of the sensor module can be selectively connected with each other to form a horseshoe-shape.

Furthermore, the base portion of the present invention can further selectively have a vertical tank, where the first magnetic element of the magnetic module is configured inside the vertical tank. Based on the design mentioned above, the power generating device of the present invention can further selectively comprise a second magnetic element. The first magnetic element and the second magnetic element are configured in the vertical tank adjacently, where the arranged orientations of the first magnetic element and the second magnetic element are parallel to the applied external force direction. The polarities of the first magnetic element and the second magnetic element corresponding to the lateral surface of the first sensor portion are different.

In addition, the present invention can further selectively comprise a second shell that is covered on the first shell, wherein the second shell has a second opening portion to allow the magnetic module to pass through. The second shell has a vertical tank, wherein the first magnetic element of the magnetic module is configured inside the vertical tank. Concurrently, the present invention can further selectively comprise at least one elastic element that is configured between the second shell and the first shell so that when the external force is applied to the power generating device, it allows the elastic element to deform. The elastic element provides a recovery force to resist the external force and the first magnetic element moves back and forth in the slide gap along the applied external force direction relative to the magnetism element through the external force and the recovery force.

Furthermore, based on the design mentioned above, the magnetism element of the sensor module of the present invention can further selectively comprise a first sensor arm and a second sensor arm. The first sensor arm comprises a first sensor portion and a first fixture portion, where the first fixture portion is configured on the first shell and the first sensor portion is extended from the first fixture portion to the first terminal of the magnetism element. The second sensor arm comprises a second sensor portion and a second fixture portion, where the second fixture portion is configured on the first shell, and the second sensor portion is extended from the second fixture portion to the second terminal of the magnetism element, in which the cross-sectional area of the first terminal is larger than the cross-sectional area of the first fixture portion, and the cross-sectional area of the second terminal is larger than the cross-sectional area of the second fixture portion.

Aside from the embodiments mentioned above, the present invention can also be presented in another way. For example, the present invention can comprise a first shell, a magnetic module, a sensor module, a second shell, and an elastic element. The first shell has a first hollow portion and a first opening portion. The magnetic module has a base portion and at least one first magnetic element. The sensor module is configured in the first hollow portion wherein the sensor module comprises a magnetism element and an induction coil coiled on or over the magnetism element and the sensor module has a slide gap. The second shell is covered on the first shell, wherein the second shell has a second opening portion to allow the magnetic module to pass through. Finally, the elastic element is configured between the magnetic module and the first shell so that when external force is applied on the power generating device to deform the elastic element. The elastic element provides a recovery force to resist the external force, and the first magnetic element moves back and forth in the slide gap along the applied external force direction relative to the magnetism element through the external force and the recovery force, wherein the distance of the first magnetic element moving back and forth is relative to the magnetism element and is within a range between two millimeters to five millimeters. For example, the first magnetic element moves back 2 mm and moves forth 2 mm, or the first magnetic element moves back 5 mm and moves forth 5 mm. In this embodiment, the induced voltage generated through the first magnetic element moving back and forth in the slide gap along an applied external force direction relative to the magnetism element is larger than three volts. The present invention can further connect or comprise a plurality of light emitting diodes that have backward connections with each other. The induced voltage is used to supply power to the light emitting diodes in order to emit light.

To summarize the statements mentioned above, the power generating device of the present invention can be used in shoe pads or ground pads. When a user walks or activates the power generating device through an external force, the power generating device will use electromagnetic induction to generate an induced current, to which the induced current can be stored to supply power to the light emitting diodes in order to emit light. It should also be noted that any appropriate electronic device that is integrated in the power generating device of the present invention has the potential to become a green product, as it does not need to connect to any type of outside power source or battery. Therefore, the power generating device of the present invention can be easily installed in shoes to generate power automatically when a user performs an action such as walking. More particularly, the lighting module of the power generating device of the present invention can increase the visibility at night, which also increases the traffic security of the pedestrian.

The advantages and spirits of the invention may be understood by the following recitations together with the appended drawings.

### BRIEF DESCRIPTION OF THE APPENDED DRAWINGS

Some of the embodiments will be described in detail, with reference to the following figures, wherein like designations denote like members, wherein:

FIG. 1A to FIG. 1D individually show the top view stereogram, bottom view stereogram, bottom view diagram, and side view diagram of the power generating device in an embodiment of the present invention.

FIG. 2A and FIG. 2B individually show the top view stereogram and the side view diagram of the power generating device when the third shell of the power generating device is removed in an embodiment of the present invention.

FIG. 3A shows the top view stereogram of the magnetic module in an embodiment of the present invention.

FIG. 3B shows the top view stereogram of the sensor module in an embodiment of the present invention.

FIG. 3C shows the stereogram of the magnetic module in an embodiment of the present invention.

FIG. 3D shows the stereogram of the magnetic module when the exposed portion is removed in an embodiment of the present invention.

FIG. 3E shows the stereogram of the present invention when the present invention has only the base portion in an embodiment of the present invention.

FIG. 3F shows the stereogram in another aspect of the present invention when the present invention has only the base portion in an embodiment of the present invention.

FIG. 3G shows the stereogram in another aspect of the present invention when the present invention has only the base portion and the elastic element in an embodiment of the present invention.

FIG. 4A and FIG. 4B show the stereogram of the present invention when the second shell and the third shell are hidden in an embodiment of the present invention.

FIG. 5 shows the function block diagram of the relationship between the power generating device and the external electronic device in another embodiment of the present invention.

FIG. 6 shows the top view stereogram of the power generating device in another embodiment of the present invention.

FIG. 7 shows the stereogram of the first shell of the power generating device in another embodiment of the present invention.

FIG. 8 shows the stereogram of the first shell, sensor module, and the elastic element of the power generating device which are assembled together in another embodiment of the present invention.

FIG. 9 to FIG. 11 show the base portion of the magnetic module, the second shell, and the combination thereof having a first magnetic element and a second magnetic element in an embodiment of the present invention.

FIG. 12 shows the stereogram of the present invention when the present invention is removing the second shell in another embodiment of the present invention.

### DETAILED DESCRIPTION OF THE INVENTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

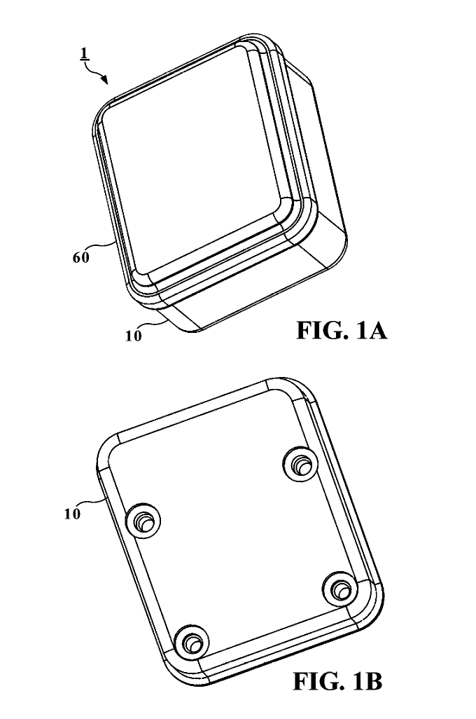

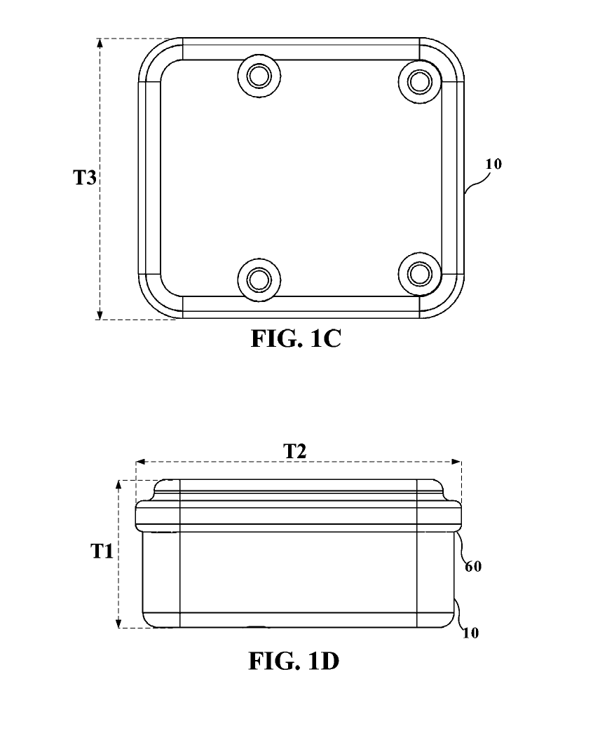

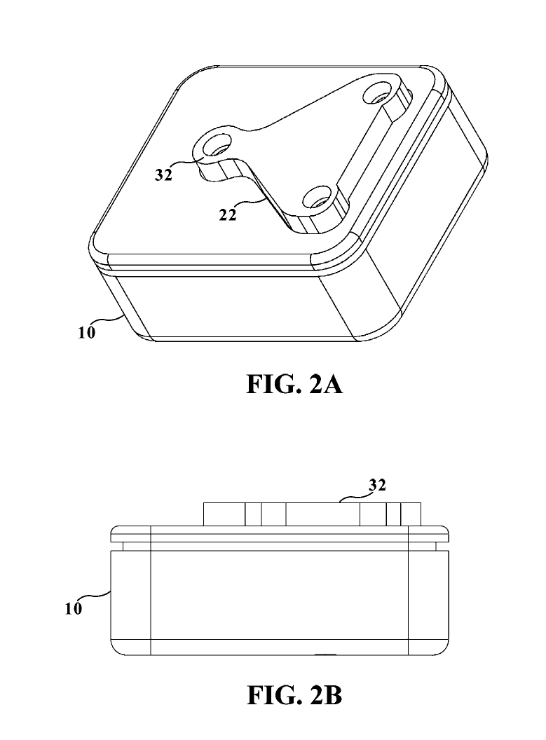

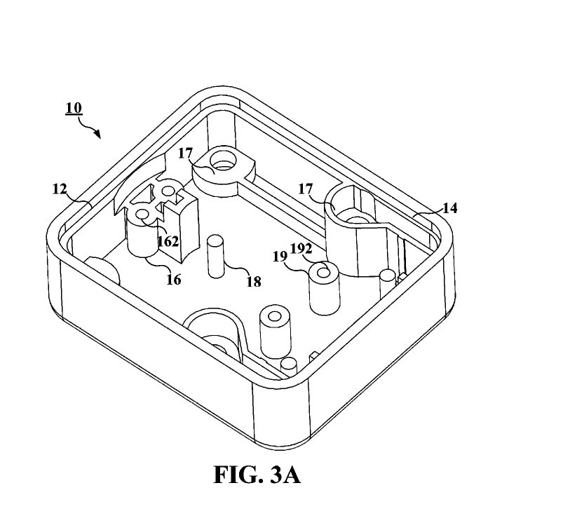

Please refer to FIG. 1A to FIG. 2B. FIG. 1A to FIG. 1D individually show the top view stereogram, bottom view stereogram, bottom view diagram, and side view diagram of the power generating device in an embodiment of the present invention. FIG. 2A and FIG. 2B individually show the top view stereogram and the side view diagram of the power generating device when the third shell of the power generating device is removed in an embodiment of the present invention.

It is worth noting that the appended drawings of the present invention are drawn according to a real life scale. Therefore, the scale and absolute magnitude of every element is a portion comprised in the present invention. In addition, in order to definitely represent the scale and the absolute magnitude of the present invention, the length T1, T2, and T3 in FIG. 1C and FIG. 1D are specifically defined. In a better embodiment of the present invention, the length T1 is 20 millimeters, T2 is 42 millimeters, and T3 is 36 millimeters.

According to the figures shown above, in this embodiment, the power generating device 1 comprises a first shell 10, a second shell 20, and a third shell 60.

The first shell 10 has a first hollow portion and a first opening portion. The second shell 20 is covered on the first opening portion to isolate the first hollow portion from outside. The surface of the second shell 20 that faces the first shell 10 is a bottom surface. In this embodiment, the bottom surface mentioned above is positioned in the first hollow portion. The second shell 20 has a hole, defined as a second opening portion 22. An exposed portion 32 of the magnetic module is exposed from the second opening portion 22, which means the top surface 321 of the exposed portion 32 exposes the second shell 20.

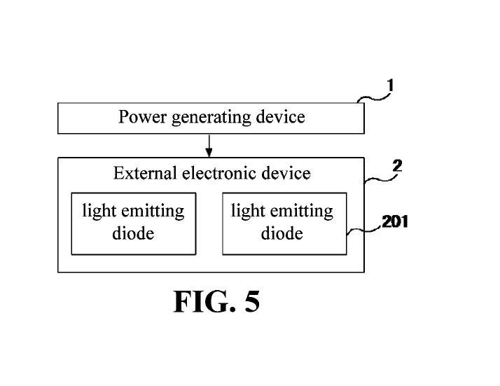

In practical application, the user can install the power generating device 1 inside the sole of a pair of shoes for instance. When the user is walking, the user will step in the shoes and apply a vertical external force on the third shell 60 of the power generating device 1 directly or indirectly, which deforms the third shell 60 and drives the magnetic module 30 mentioned above to perform a vertical movement, wherein the vertical movement is a relative movement relating to the sensor module configured in the first shell 10. The induction coil of the sensor module inducts a change in the magnetic flux to generate an induced current. After collecting the generated induced current, the induced current can be supplied to the external electronic device 2 that is coupled with the power generating device 1, such as a light emitting diode 201. FIG. 5 is an example of this embodiment.

Please refer to FIG. 1A to FIG. 2B again. In this embodiment, the third shell 60 is a soft cover. The purpose of the soft cover is to prevent a foreign object from the second shell 20 to enter the first hollow portion 12 through the second opening portion 22 of the second shell 20. The third shell 60 of the present invention is not limited to the soft cover, which can alternatively be replaced by a hard cover, covered on one terminal of the second shell 20. When the power generating device 1 needs to be used, the user can remove the third shell 60 to allow the second shell 20 to be directly exposed and used. That is to say, the present invention does not necessarily need to set the third shell 60.

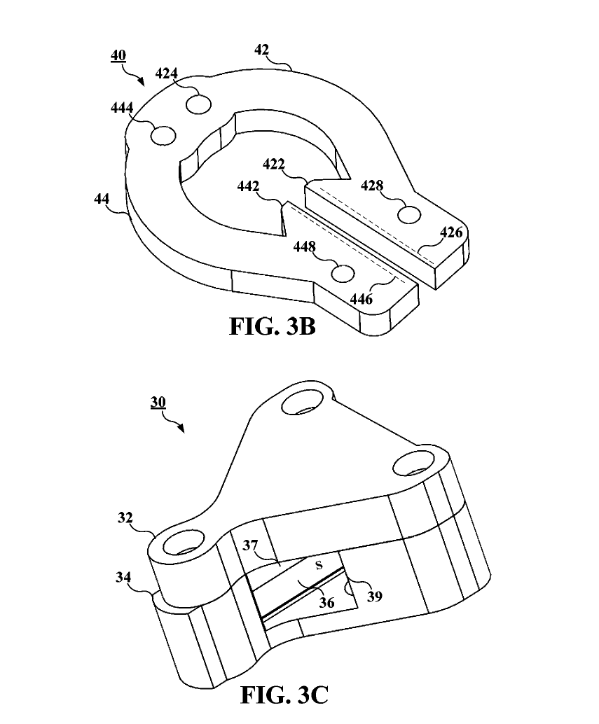

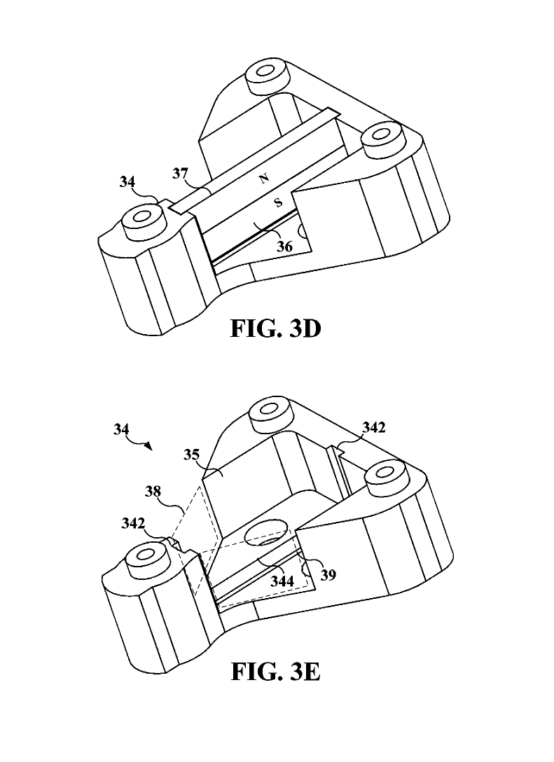

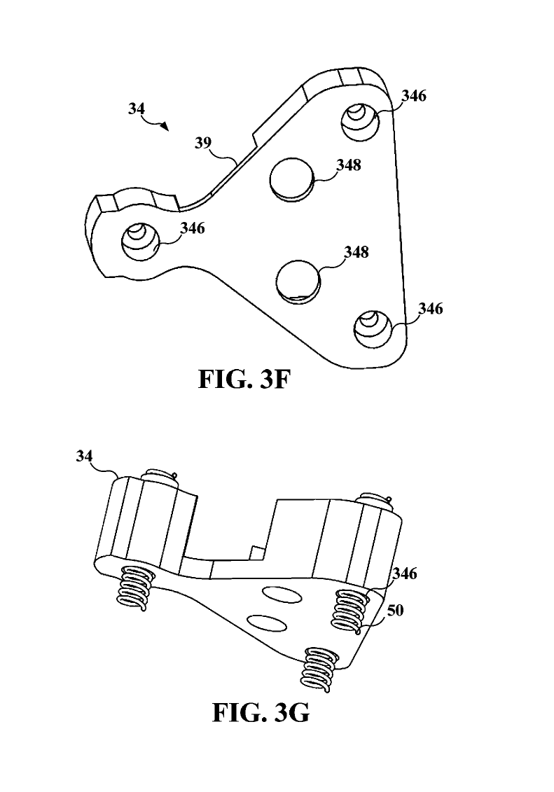

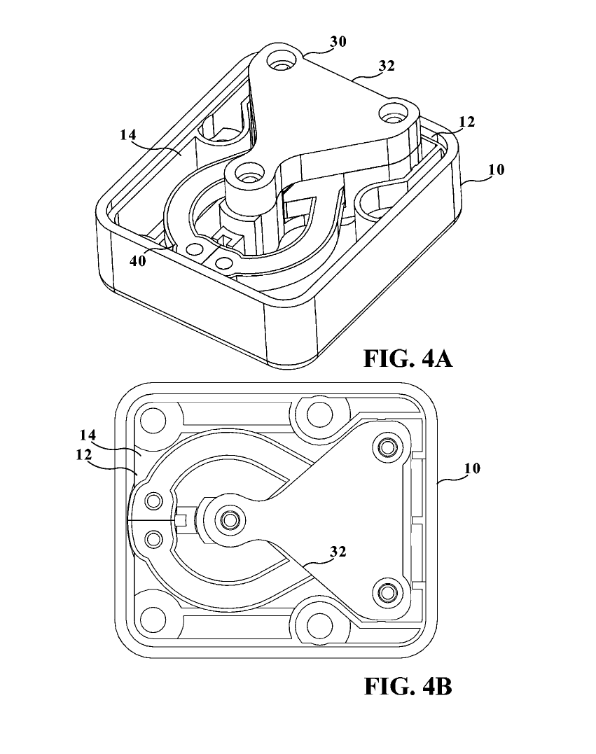

Before further illustrating the structure of the present invention, the following statement will illustrate the design of every element first. Please refer to FIG. 3A. FIG. 3A shows the top view stereogram of the magnetic module in an embodiment of the present invention. In this embodiment, the first shell 10 of the present invention forms a square bowl shape and has a first hollow portion 12 and a first opening portion 14. There are many carriers 16 comprised for fixing and maintaining the sensor module 40 at a predetermined height in a first hollow portion 12 through a plurality of fixture elements, such as screws. Every carrier 16 comprises a fixture hole 162 that is used to allow a fixture element to pass through and secure the device. Moreover, there are many convex pillars 18 comprised in the first shell 10, adjusted for every kind of elastic element to be set on, for example springs. The first shell 10 can further comprise a plurality of fixture pillars 19, wherein the fixture pillars 19 can have a fixture hole 192 inside. Additionally, every corner of the first shell 10 has a fixed position hollow pillar 17 that passes through the first shell 100 and connects outside. The circle shown in FIG. 1C is the hole where the fixed position hollow pillar 17 of the first shell 10 passes through.

Please refer to FIG. 3B. FIG. 3B shows the top view stereogram of the sensor module in an embodiment of the present invention. In this embodiment, the sensor module 40 is formed by a magnetism element 41 and an induction coil 426 and 446 (to maintain the simplicity of the FIG., the induction coil is shown with the dotted line), which is coiled on, or buried inside the magnetism element 41. The magnetism element 41 is formed by the first sensor arm 42 and the second sensor arm 44. The terminal of the first sensor arm 42 and the second arm 44 are defined as a first terminal 429 and a second terminal 449. The first sensor arm 42 comprises a first sensor portion 422 and a first fixture portion 424, wherein the first sensor portion 422 is extended horizontally from the first fixture portion 424. At least one induction coil (or can also be called a first induction coil set) 426 (shown by the dotted line) is coiled on the first sensor arm 42. Correspondingly, the second sensor arm 44 has a second sensor portion 442 and a second fixture portion 444, wherein the second sensor portion 442 is extended horizontally from the second fixture portion 444. Likewise, at least one induction coil (or can also be called a second induction coil set) 446 is coiled on the second sensor arm 44. In addition, the first sensor arm 42 and the second sensor arm 44 individually have many holes 428 and 448 that are used to secure the first sensor arm 42 and the second sensor arm 44 on the first shell 10 using the external fixture element or any other methods. In this embodiment, the position and the scale of every hole 428 and 448 mentioned above correspond with the fixture hole 192 of the fixture pillars 19 of the first shell 10.

Additionally, in this embodiment, the extending direction of the first sensor arm 42 and the second sensor arm 44 of the magnetism element 41 is perpendicular to the applied external force direction. In this embodiment, the first sensor arm 42 and the second sensor arm 44 of the magnetism element 41 are connected with each other and form a horseshoe-shaped structure, wherein the horseshoe-shaped structure has a gap formed between the first terminal 429 and the second terminal 449 and the gap is defined as a slide gap 43 for each magnetic element of the magnetic module 30 to be able to slide in. It is worth noting that the magnetism element 41 in this embodiment is an integral single element, but in practice, in order to wind the wire on the horseshoe-shaped sensor module 40 conveniently, the horseshoe-shaped magnetism element 41 can be divided into two parts as shown in the figures so that the central of the horseshoe-shaped magnetism element 41 is broken off but still remains a small connection that is only between them. Therefore, the horseshoe-shaped metal can be opened safely in order to wind the wire conveniently. After winding the wire, the horseshoe-shaped metal needs to be recovered and fixed. In other applications, the first sensor arm 42 and the second sensor arm 44 of the magnetism element 41 can be set individually according to the required conditions, and is not limited to only being set integrally, as shown in this embodiment. According to the statement mentioned above, in this embodiment, the magnetism element 41 is integral. But in practice, the first sensor portion 422 and the second sensor portion 442 of the terminal of the first sensor arm 42 and the second sensor arm 44 can individually be a single element and connected to the terminal of the first sensor arm 42 and the second sensor arm 44 through the fixture element, such as screws, in order to replace the original design of the present invention.

Please refer to FIG. 3C to FIG. 3G. FIG. 3C shows the stereogram of the magnetic module in an embodiment of the present invention. FIG. 3D shows the stereogram of the magnetic module when the exposed portion is removed in an embodiment of the present invention. FIG. 3E shows the stereogram of the present invention when the present invention has only the base portion in an embodiment of the present invention. FIG. 3F shows the stereogram in another aspect of the present invention when the present invention has only the base portion in an embodiment of the present invention. Finally, FIG. 3G shows the stereogram in another aspect of the present invention when the present invention has only the base portion and the elastic element in an embodiment of the present invention. In this embodiment, the magnetic module 30 is formed by an exposed portion 32, a base portion 34, a first magnetic element 36, and a second magnetic element 37. The exposed portion 32 forms a triangle plate structure and is configured on the base portion 34. The base portion 34 has a dent, so when the exposed portion 32 is covered on the base portion 34 and fixed with each other, an activity space 35 is formed between them. The shape of the exposed portion 32 of the magnetic module 30 corresponds with the second opening portion 22 of the second shell 20.

The base portion 34 of the magnetic module 30 has a first seat opening 38 and a second seat opening 39. The activity space 35 is connected to the first hollow portion 12 through the first seat opening 38 and the second seat opening 39. Also, in this embodiment, the magnetic module 30 of the present invention comprises a first magnetic element 36 and a second magnetic element 37. The first magnetic element 36 and the second magnetic element 37 are individually configured in a plurality of vertical tanks 342 located on the vertical side wall of the magnetic module 30. The distance and width of the vertical tanks 342 correspond to the first magnetic element 36 and the second magnetic element 37 to allow the first magnetic element 36 and the second magnetic element 37 to be configured inside. Aside from the vertical tanks 342 mentioned above, a horizontal dent 344 can also be set on the inner surface of the base portion 34 of the magnetic module 30 to allow the first magnetic element 36 and the second magnetic element 37 to be configured inside.

In another aspect of the present invention, in this embodiment, the second magnetic element 37 is configured on a terminal of the first magnetic element 36 corresponding to the applied external force direction, which means the arranged orientations of the first magnetic element and the second magnetic element are parallel with the applied external force direction. According to the figures, the polarities of the first magnetic element 36 and the second magnetic element 37 corresponding to the lateral surface of the first sensor portion 422 are different. Using the difference in the two polarities, the electromotive force can be fully utilized to maintain or improve the power generation efficiency. It is worth noting that the material of the magnetic element is not limited by the present invention. For example, the first magnetic element 36 and the second magnetic element 37 can be manufactured by rubidium, iron, boron, or any other applicable material that could act as a highly magnetic magnet. More specifically, if the element can provide a magnetic force it is comprised in the present invention.

Furthermore, the bottom surface of the base portion 34 has a plurality of fixture holes 348, wherein the scale and position of the fixture holes 348 corresponds to the fixture pillars 19 of the first shell 10. Moreover, the bottom surface of the base portion 34 also has a plurality of ladder-shaped dents 346 that are adjusted for the elastic element to be configured in. The scale and position of the ladder-shaped dents 346 mentioned above are corresponding to every convex pillar 18 of the first shell 10.

After illustrating the design of every element of the present invention, the following statement will illustrate the relationship between every element after assembling. When assembling, the first step is to prepare a first shell 10 and then set the elastic element 50 on every convex pillar 18 of the first shell 10. Next, set the fixture hole 348 of the base portion 34 of the magnetic module 30 on every fixture pillar 19 of the first shell 10 and assure the terminal of the elastic element 50, which corresponds further from the first shell 10 and is configured in the ladder-shaped dent 346. The first magnetic element 36 and the second magnetic element 37 have been configured in the base portion 34 in advance.

Then, individually configure the first fixture portion 424 of the first sensor arm 42 of the magnetism element 41 and the second fixture portion 444 of the second sensor arm 44 in the fixture hole 162 of the carrier 16 of the first shell 10 through the fixture element, such as screws, in order to maintain the position of the first fixture portion 424 of the first sensor arm 42 of the magnetism element 41 and the second fixture portion 444 of the second sensor arm 44.

At the same time, the first sensor arm 42 and the second sensor arm 44 of the sensor module 40 individually penetrates into the activity space 35 through the first seat opening 38 and the second seat opening 39, to be individually set at the two sides of the first sensor portion 422 of the first magnetic element 36 and the second sensor portion 442 of the second magnetic element 37 in order to surround the first sensor portion 422 of the first magnetic element 36 and the second sensor portion 442 of the second magnetic element 37. The gap between the first sensor arm 42 and the second sensor arm 44 allows the first magnetic element 36 or the second magnetic element 37 to slide in and not be made in direct contact with the first sensor portion 422 and the second sensor portion 442.

Afterwards, configure the exposed portion 32 on the base portion 34 using the fixture element, such as screws, in order to form the activity space 35 between the exposed portion 32 and the base portion 34. The final product is shown in FIG. 4A and FIG. 4B, wherein FIG. 4A and FIG. 4B show the stereogram of the present invention when the third shell and the second shell are hidden in an embodiment of the present invention.

Finally, align the hollow pillars of the second shell 20 according to the fixed position hollow pillars in every corner of the first shell 10. The fixed position hollow pillars of the first shell 10 passes through the first shell 10 and connects the inside and outside. Therefore, when setting it up, the fixture element, such as screws, can be fixed into the hole of the fixed position hollow pillars to secure the relative position of the first shell 10 and the second shell 20, which is shown in FIG. 2A. Then after being covered by the third shell, the setup is finished, as shown in FIG. 1A.

In application, the user applies an external force on the third shell 60 to deform the third shell 60 so that the third shell 60 will drive the exposed portion 32 of the magnetic module 30 to generate a vertical movement along the applied external force direction. The first magnetic element 35 and the second magnetic element 37 of the magnetic module 30 slide in the gap between the first sensor portion 422 and the second sensor portion 442 in order to generate an electromotive force. At the same time, every elastic element 50 set between the magnetic module 30 and the first shell 10 will be compressed to then provide a vertical resisting force to the magnetic module 30. If the external force disappears when the elastic element 50 is compressed, the elastic element 50 will lift the magnetic module 30 with the resisting force, which achieves the goal of restoring the original position. The distance of the unidirectional path is about two millimeters to five millimeters in the embodiment of the figures. The elastic element 50 is set between the base portion 34 and the first shell 10 of the magnetic module 30. When the external force is applied on the power generating device to deform the elastic element 50, the elastic element provides a recovery force to resist the external force, and the first magnetic element then moves back and forth in the slide gap along the applied external force direction relative to the magnetism element using the external force and the recovery force. When the external force is not applied on the power generating device, the top surface 321 of the exposed portion 32 will pass through the second shell to the position between the second shell and the third shell.

In another aspect of the present invention, if the power generating device of the present invention is set inside a pair of shoes, the user will compress the exposed portion 32 of the magnetic module 30 when walking, which drives the first magnetic element 36 and the second magnetic element 37 to move together to change polarities (the polarity of the top of the magnet and the polarity of the bottom of the magnet are different). The direction of the magnetic flux of the horseshoe-shaped sensor module 40 is then changed, which causes the alternation of the magnetic flux to be generated in a short amount of time, while the wire of the induction coil 42 of the horseshoe-shaped metal will induct a forward voltage. When there is an external force applied on the exposed portion 32 of the magnetic module, the elastic element 50, such as a spring, will be compressed as well. When the user's foot is lifted off the ground, the elastic element 50 will push the magnet of the first magnetic element 36 and the second magnetic element 37 back to its original position, while changing the polarity of the magnet again to induct voltage in the other direction. At the same time, if the light emitting diodes 201 of the power generating device 1 and the external electronic device 2 are negatively and positively connected in parallel, the voltage generated from the power generating device 1 can be fully used, which allows for at least one set of light emitting diodes 201 to emit light whether or not the user's foot is pressing down on the device or being lifted from the ground.

For the output polarity, the design of the present invention can generate an induced voltage with a pulse shape or a triangle wave when the present invention is applied with an external pressing force. The peak value is between 6.5 volts to 15 volts. The width of the pulse is about 16 ms to 42 ms, wherein if the width of the pulse is shorter (which means the external pressing force is larger), the generated peak value of the induced voltage is higher. When returning to its original position, an induced voltage can also be generated, wherein the width of the pulse of the induced voltage is about 88 ms and the peak value of the induced voltage is about 3 volts. Naturally, if the spring return force is larger, the width of the pulse will be shorter and the peak value will be higher.

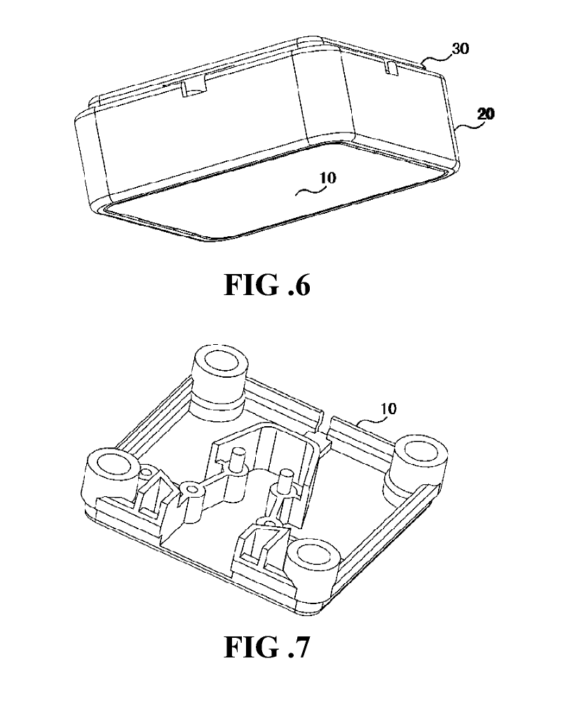

Besides the design mentioned above, based on the design of the present invention, the applicant can also provide an extended design of the power generating device. Please refer to FIG. 6. FIG. 6 shows the top view stereogram of the power generating device in another embodiment of the present invention. As shown in FIG. 6, a first shell 10, a second shell 20 and a magnetic module 30 is comprised.

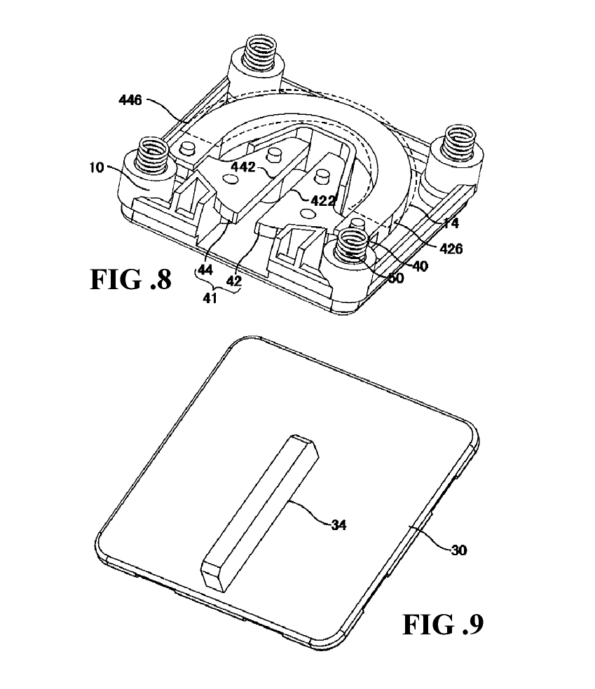

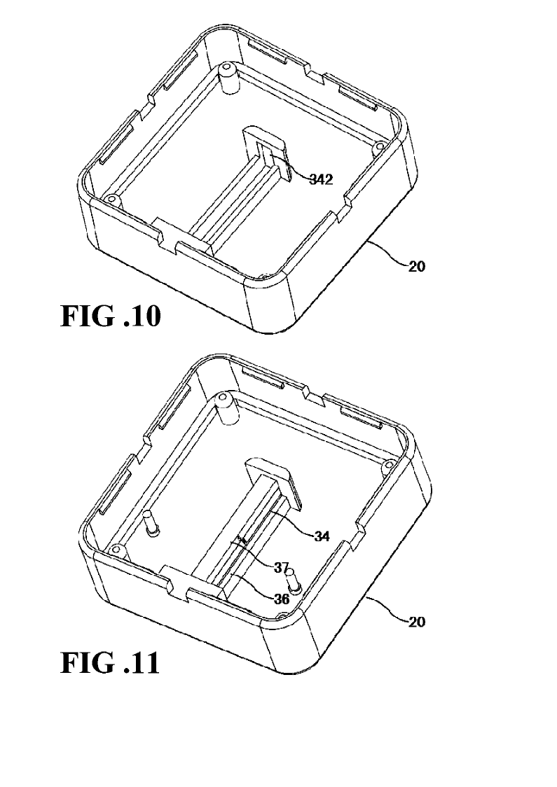

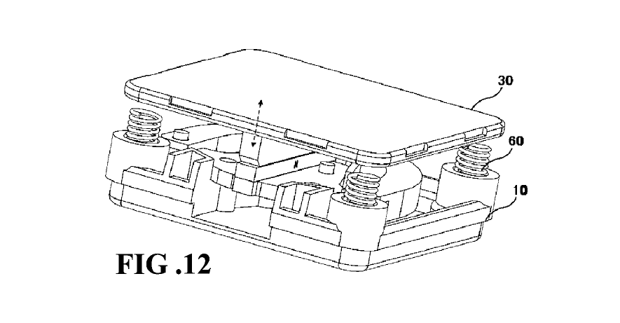

Please refer to FIG. 7 to FIG. 8. FIG. 7 shows the stereogram of the first shell of the power generating device in another embodiment of the present invention, while FIG. 8 shows the stereogram of the first shell, sensor module, and the elastic element of the power generating device which are assembled together in another embodiment of the present invention. FIG. 9 to FIG. 11 show the base portion of the magnetic module, the second shell, and the combination thereof having the first magnetic element and the second magnetic element in an embodiment of the present invention and FIG. 12 shows the stereogram of the present invention when the present invention is removing the second shell in another embodiment of the present invention.

As shown in the figures, the extended design is also formed by a first shell 10, a second shell 20, a magnetic module 30, a sensor module 40, and at least one elastic element 50. The sensor module 40 also has a magnetism element 41 and an induction coil 426 and 446 coiled on the magnetism element 41. The sensor module 40 is configured in the first shell 10 through a rod. The difference between the extended design and the better embodiment is that the first sensor portion 422 and the second sensor portion 442 are external elements, which are connected to the other portion of the magnetism element 41 through fixture elements.

Moreover, the second shell 20 is covering on the first shell 10. The second shell 20 has a second opening portion 22 for the base portion 34 of the magnetic module 30 to pass through and jut out from the second shell 20. The difference between this embodiment and the embodiment mentioned above is that the base portion 34 does not have the vertical tank and the horizontal dent to secure the first magnetic element 36 and the second element 37. Instead, the vertical tank 342 is formed on the second opening portion 22 of the second shell 20 for the first magnetic element 36 and the second element 37 to be configured in. As shown in the figures, the length and the width of the first magnetic element 36 and the second element 37 are a little longer than the second opening portion 22.

When in use, an external force is applied on the magnetic module 30 or the first shell 10, to which the external force drives the magnetic module 30 and the sensor module 40 to generate a relative movement that drives the first magnetic element 36 and the induction coil 42 of the magnetic module 30 along a vertical direction, which allows the induction coil to induct a change in the magnetic flux in order to generate an induced current to be used by the connected electronic devices.

In another aspect of the present invention, this design also comprises at least one or a plurality of elastic elements 60. Each elastic element 60 is configured between the second shell and the first shell. When the external force is applied on the power generating device 10 to deform the elastic, the elastic element provides a recovery force to resist the external force, and the first magnetic element moves back and forth in the slide gap along the applied external force direction relative to the magnetism element using the external force and the recovery force.

Furthermore, in this embodiment, the first sensor arm 42 comprises a first sensor portion 422 and a first fixture portion 424. The first fixture portion 424 is configured on the first shell 10. The first sensor portion 422 is extended from the first fixture portion 424 to the first terminal 429 of the magnetism element 41, wherein the first terminal 429 is the end of the magnetism element. At the same time, the second sensor arm 44 comprises a second sensor portion 442 and a second fixture portion 444. The second fixture portion 444 is configured on the first shell 10. The second sensor portion 442 is extended from the second fixture portion 444 to the second terminal 449 of the magnetism element 41, wherein the second terminal 449 is the other end relative to the first terminal of the magnetism element.

In each embodiment in FIG. 4A and FIG. 8, the cross-sectional area of the first terminal of the magnetism element 41 is larger than the cross-sectional area of the first fixture portion 424, and the cross-sectional area of the second terminal is larger than the cross-sectional area of the second fixture portion 444. The cross-sectional area of the first terminal and the second terminal mentioned above can be understood as the cross-sectional area of every sensor portion of the magnetism element 41 that is exposed and faces the magnetic element. Every cross-sectional area of the fixture portion can be understood as the cross-sectional area of the normal vector which is perpendicular to the extended direction of the fixture portion. Moreover, in the embodiment in FIG. 8, the maximum width of the cross-section of the normal vector of the extended direction of the first terminal and the second terminal mentioned above is two to four times longer than the maximum width of the cross-section of the normal vector of the extended direction of the fixture portion.

To summarize the statements mentioned above, the power generating device of the present invention can be used in shoe pads or ground pads. When a user walks or activates the power generating device through an external force, the power generating device will use electromagnetic induction to generate an induced current, to which the induced current can be stored to supply power to the light emitting diodes in order to emit light. It should also be noted that any appropriate electronic device that is integrated in the power generating device of the present invention has the potential to become a green product, as it does not need to connect to any type of outside power source or battery. Therefore, the power generating device of the present invention can be easily installed in shoes to generate power automatically when a user performs an action such as walking. More particularly, the lighting module of the power generating device of the present invention can increase the degree of recognition at night, which also increases the traffic security of the pedestrian.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A power generating device, comprising:
a first shell having a first hollow portion and a first opening portion;
a magnetic module having a base portion and at least one first magnetic element; and
a sensor module configured in the first hollow portion, the sensor module comprising a magnetism element and an induction coil coiled over the magnetism element, the magnetism element comprising a first terminal, a second terminal, and a slide gap between the first terminal and the second terminal;
wherein when an external force is applied to the power generating device, the first magnetic element moves relative to the slide gap, for allowing the induction coil to generate an induced current.

2. The power generating device of claim 1, further comprising:
a second shell covering the first opening portion, the second shell having a second opening portion for the magnetic module to pass through, wherein a bottom surface of the base portion is positioned in the first hollow portion.

3. The power generating device of claim 2, further comprising:
a third shell, covering the second shell, wherein when the external force is applied to the power generating device to deform the third shell, the third shell drives the base portion of the magnetic module to move into the first hollow portion.

4. The power generating device of claim 3, the magnetic module further comprising an exposed portion connected to the base portion, wherein when the external force is not applied to the power generating device, a top surface of the exposed portion passes through the second shell to the position between the second shell and the third shell.

5. The power generating device of claim 1, further comprising:
at least one elastic element configured between the base portion of the magnetic module and the first shell, wherein when the external force is applied to the power generating device to deform the elastic element, the elastic element generates a recovery force to resist the external force such that the first magnetic element moves back and forth along the slide gap.

6. The power generating device of claim 1, wherein the magnetism element of the sensor module comprising:
a first sensor arm, wherein the first sensor arm comprises a first sensor portion and a first fixture portion, the first fixture portion is configured over the first shell, and the first sensor portion is extended from the first fixture portion to the first terminal of the magnetism element; and
a second sensor arm, wherein the second sensor arm comprises a second sensor portion and a second fixture portion, the second fixture portion is configured over the first shell, and the second sensor portion is extended from the second fixture portion to the second terminal of the magnetism element.

7. The power generating device of claim 6, wherein the base portion of the magnetic module has an activity space, a first seat opening, and a second seat opening, and the activity space is connected to the first hollow portion through the first seat opening and the second seat opening, the first sensor arm of the sensor module enters the activity space through the first seat opening for being configured on one side of the first magnetic element, the second sensor arm of the sensor module enters the activity space through the second seat opening for being configured on the other side of the first magnetic element, and the first terminal and the second terminal of the magnetism element are positioned in the activity space.

8. The power generating device of claim 7, wherein the first sensor arm and the second sensor arm of the sensor module are connected with each other and form a horseshoe-shape.

9. The power generating device of claim 1, wherein the base portion has a vertical tank, and the first magnetic element of the magnetic module is configured inside the vertical tank.

10. The power generating device of claim 9, wherein the magnetic module further comprises a second magnetic element, the first magnetic element and the second magnetic element are configured inside the vertical tank adjacently, and an arranged orientation of the first magnetic element and the second magnetic element is parallel with an applied direction of the external force.

11. The power generating device of claim 10, wherein the polarities of the first magnetic element and the second magnetic element corresponding to the lateral surface of the first sensor portion are different.

12. The power generating device of claim 1, further comprising a second shell, covering the first shell, wherein the second shell has a second opening portion for the magnetic module to pass through, and the second shell has a vertical tank, wherein the first magnetic element of the magnetic module is configured inside the vertical tank.

13. The power generating device of claim 12, further comprising at least one elastic element configured between the second shell and the first shell, wherein when an external force is applied to the power generating device to deform the elastic element, the elastic element provides a recovery force to resist the external force such that the first magnetic element moves back and forth along the slide gap.

14. The power generating device of claim 12, wherein the magnetism element of the sensor module comprises:
a first sensor arm, wherein the first sensor arm comprises a first sensor portion and a first fixture portion, the first fixture portion is configured on the first shell, and the first sensor portion is extended from the first fixture portion to the first terminal of the magnetism element; and
a second sensor arm, wherein the second sensor arm comprises a second sensor portion and a second fixture portion, the second fixture portion is configured on the first shell, and the second sensor portion is extended from the second fixture portion to the second terminal of the magnetism element;
wherein the cross-sectional area of the first terminal is larger than the cross-sectional area of the first fixture portion, and the cross-sectional area of the second terminal is larger than the cross-sectional area of the second fixture portion.

15. A power generating device, comprising:
a first shell having a first hollow portion and a first opening portion;
a magnetic module having a base portion and a first magnetic element;
a sensor module configured in the first hollow portion, wherein the sensor module comprises a magnetism element and an induction coil coiled over the magnetism element, and the sensor module has a slide gap;
a second shell covering the first shell, wherein the second shell has a second opening portion for the magnetic module to pass through; and
an elastic element configured between the magnetic module and the first shell, and the first magnetic element capably moving back and forth along the slide gap;
wherein the distance of the first magnetic element moving back and forth is within a range between two millimeters to five millimeters.

16. The power generating device of claim 15, wherein an induced voltage generated through the first magnetic element moving along the slide gap is larger than three volts.

17. The power generating device of claim 16, further comprising a light emitting diode, and the induced voltage is used for supplying power for the light emitting diode to emit light.

18. The power generating device of claim 15, wherein the induced voltage generated through the first magnetic element moving along the slide gap is between 6.5 volts and 15 volts.

19. A object, comprising:
a body; and
a power generating device embedded in the body, the power generating device comprising:
a first shell having a first hollow portion and a first opening portion;
a magnetic module having a base portion and at least one first magnetic element; and
a sensor module configured in the first hollow portion, the sensor module comprising a magnetism element and an induction coil coiled over the magnetism element, the magnetism element comprising a first terminal, a second terminal, and a slide gap between the first terminal and the second terminal;
wherein when an external force is applied to the power generating device, the first magnetic element capably moves back and forth along the slide gap to generate an induced voltage;
wherein the distance of the first magnetic element moving back and forth along the slide gap is between 2 mm to 5 mm, and the induced voltage is greater than 3V.
